(19) United States
(12) Patent Application Publication
(10) Pub. No.: US 2024/0155458 A1
(43) Pub. Date: May 9, 2024

(54) FAST DATA PATH SWITCH IN LOWER LAYER MOBILITY

(71) Applicant: QUALCOMM Incorporated, San Diego, CA (US)

(72) Inventors: Naeem AKL, Bridgewater, NJ (US); Jelena DAMNJANOVIC, Del Mar, CA (US)

(21) Appl. No.: 18/500,696

(22) Filed: Nov. 2, 2023

Related U.S. Application Data
(60) Provisional application No. 63/422,902, filed on Nov. 4, 2022.

(51) Int. Cl. H04W 36/36; H04W 36/32

(52) U.S. Cl. CPC H04W 36/362; H04W 36/32

(57) ABSTRACT

Certain aspects of the present disclosure provide a method of wireless communication at a first distributed unit (DU), generally including detecting a condition related to a cell switch of a user equipment (UE) that supports dynamic mobility signaling via physical (PHY) layer or medium access control (MAC) layer signaling, wherein the condition is detected while a first data path between a centralized unit (CU) and the UE via the first DU is active and transmitting, based on detection of the condition, an indication to trigger the CU to begin forwarding data to the UE via a second data path involving a second DU involved in the cell switch.

### CROSS-REFERENCE TO RELATED APPLICATION

This application claims benefit of and priority to U.S. Provisional Application No. 63/422,902, filed Nov. 4, 2022, which is assigned to the assignee hereof and hereby expressly incorporated by reference in its entirety as if fully set forth below and for all applicable purposes.

### FIELD OF THE DISCLOSURE

Aspects of the present disclosure relate to wireless communications, and more particularly, to techniques for expediting a data path switch for a user equipment (UE) that supports cell changes via dynamic signaling.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a first distributed unit (DU). The method includes detecting a condition related to a cell switch of a user equipment (UE) that supports dynamic mobility signaling via physical (PHY) layer or medium access control (MAC) layer signaling, wherein the condition is detected while a first data path between a centralized unit (CU) and the UE via the first DU is active; and transmitting, based on detection of the condition, an indication to trigger the CU to begin forwarding data to the UE via a second data path involving a second DU involved in the cell switch.

Another aspect provides a method of wireless communication at a CU. The method includes receiving, from a first DU, an indication of a pending cell switch of a UE that supports dynamic mobility signaling via PHY layer or MAC layer signaling, wherein the indication is received while a first data path between the CU and the UE via the first DU is active; and initiating, based on the indication, forwarding of data to the UE via a second data path involving a second DU involved in the cell switch.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example radio access network (RAN) architecture.

FIG. 6 depicts an example of a centralized unit (CU) with a separation of control plane (CP) and user plane (UP) functionality.

FIGS. 7, 8 and 9 depict examples of different mobility scenarios.

FIG. 10 depicts an example of UE mobility, in accordance with some aspects of the present disclosure.

FIGS. 11-12 depict example mobility scenarios.

FIG. 13 depicts an example mobility scenario with a data path switch, in accordance with aspects of the present disclosure.

FIGS. 14-15 depict example mobility scenarios with a data path switch, in accordance with aspects of the present disclosure.

FIG. 16 depicts a method for wireless communications.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for expediting a data path switch for a user equipment (UE) that supports cell changes via dynamic signaling.

In advanced wireless systems, mobility and beam management procedures are in place to help maintain network connections for a user equipment (UE) as it moves between the coverage areas of different cells. Mobility procedures generally refer to mechanisms that allow a UE to transition from being served by a source cell to being served by a target cell. Beam management procedures generally refer to mechanisms for selecting beams suitable for communicating with a network entity, such as a transmission reception point (TRP), of one or more cells.

In multi-beam operation, more efficient uplink/downlink beam management may allow for increased intra-cell and inter-cell mobility based on lower layer (e.g., PHY/L1 and/or MAC/L2-centric mobility) and/or a larger number of transmission configuration indicator (TCI) states. For example, the states may enable the use of a common beam for data and control transmission and reception for UL and DL operations and enhanced signaling mechanisms to improve latency and efficiency.

In some cases, one or more components of a base station may be disaggregated, including a central unit (CU), one or more distributed units (DUs), and one or more radio units (RUs). In such cases, a CU may communicate with one or more DUs via respective midhaul links, such as an F1 interface, while DUs may communicate with one or more RUs via respective fronthaul links. The RUs may represent cells and may communicate with respective UEs via one or more radio frequency (RF) access links.

In handover scenarios between such components, the handover configuration may precede handover execution by the UE. As a result, a CU may initiate a UE context setup procedure towards a candidate DU before the UE performs handover. According to this procedure, the CU control plane (CU-CP) may setup a user plane interface (F1-U) between a candidate DU and the CU user plane (CU-UP). The CU-CP may later suspend (or release) the F1-U if the UE selects a target cell served by a different candidate DU.

In some cases, a gNB-CU-CP may setup the F1-U between the gNB-CU-UP and a candidate gNB-DU before the UE executes L1/L2-triggered mobility. In such cases, there are various options for forwarding downlink (DL) data on the F1-U. According to a first option, the gNB-CU only activates forwarding of the F1-U protocol data units (PDUs) towards the candidate DU after the UE successfully accesses a target cell served by the candidate DU. While this first option may help minimize redundant transmission of PDUs by only activating F1-U towards the selected target cell, there may be some interruption time of the user plane (UP). According to a second option, a data path may be pre-emptively setup towards all DUs that serve a candidate cell for UE mobility before the UE switches cells. Potentially, data is forwarded to all DUs and, when the UE performs a cell switch, only data path to the DU serving the target cell is activated. This option has additional overhead due to resource reservation at all of the candidate target DUs.

According to certain aspects of the present disclosure, however, a CU may activate forwarding of F1-U PDUs towards a candidate DU before or after the UE executes an L1/L2-triggered mobility to the associated target cell. As will be described in greater detail below, a source DU may transmit an indication to trigger the CU to begin forwarding data to the UE via a second data path involving a second DU involved in the cell switch. The techniques proposed herein may represent a tradeoff between the first and second (e.g., late and early) data forwarding options described above, helping to achieve a fast data path switch, while limiting the amount of overhead.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

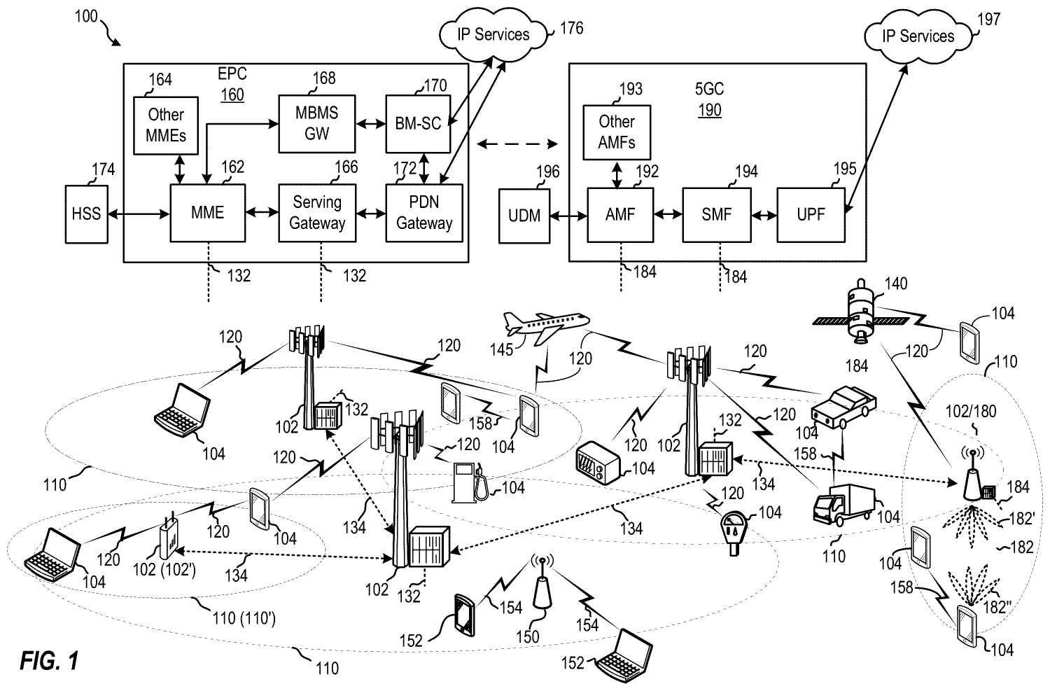

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BS s 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

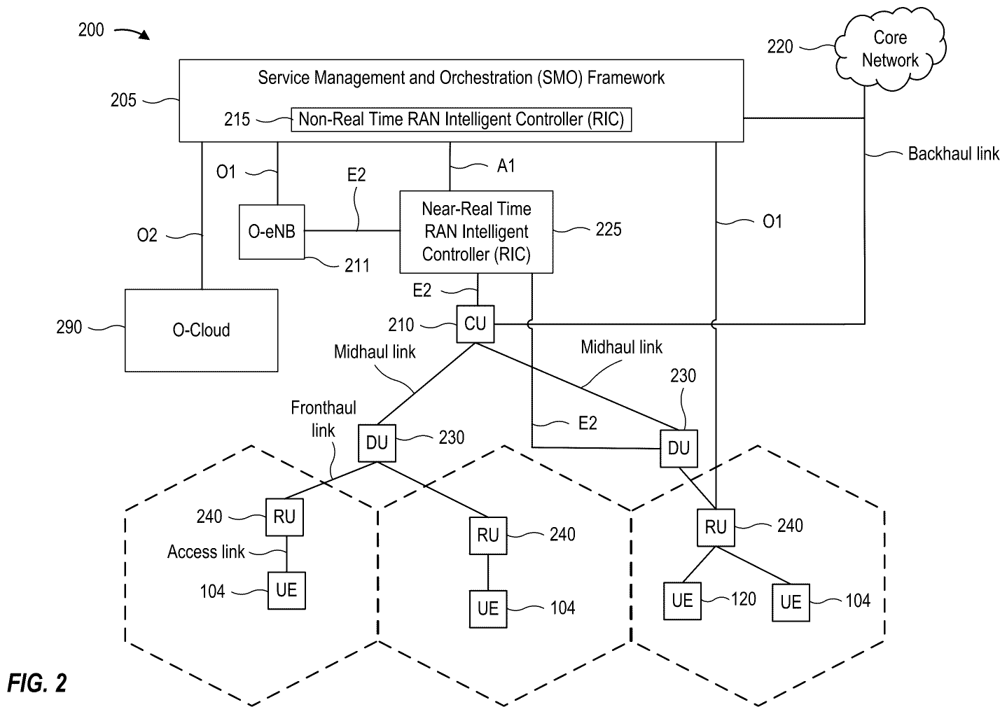

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BS s 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3r d Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

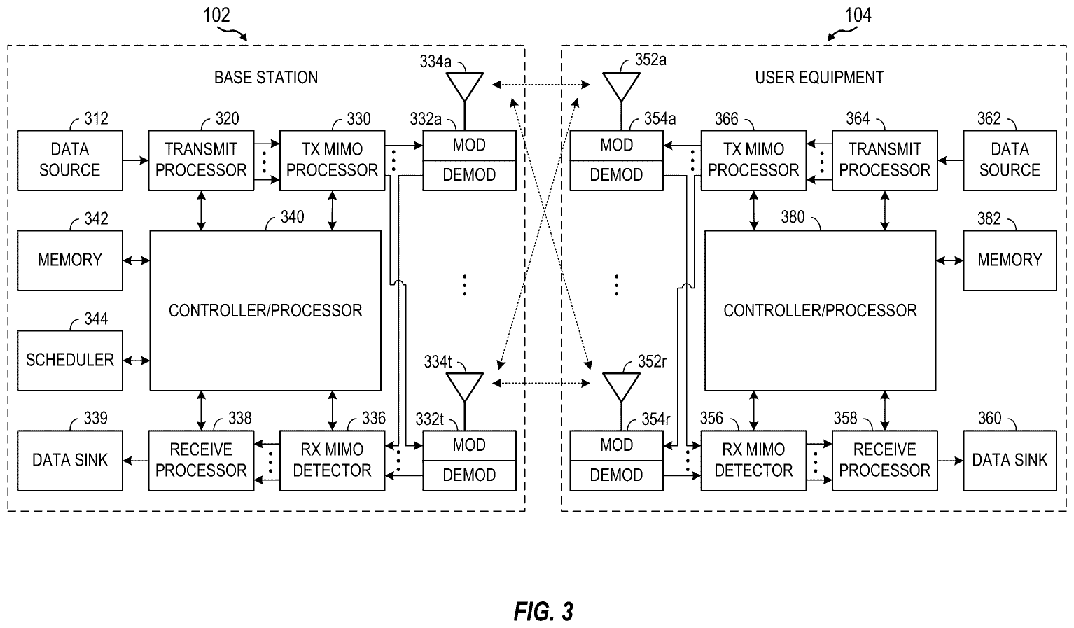

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

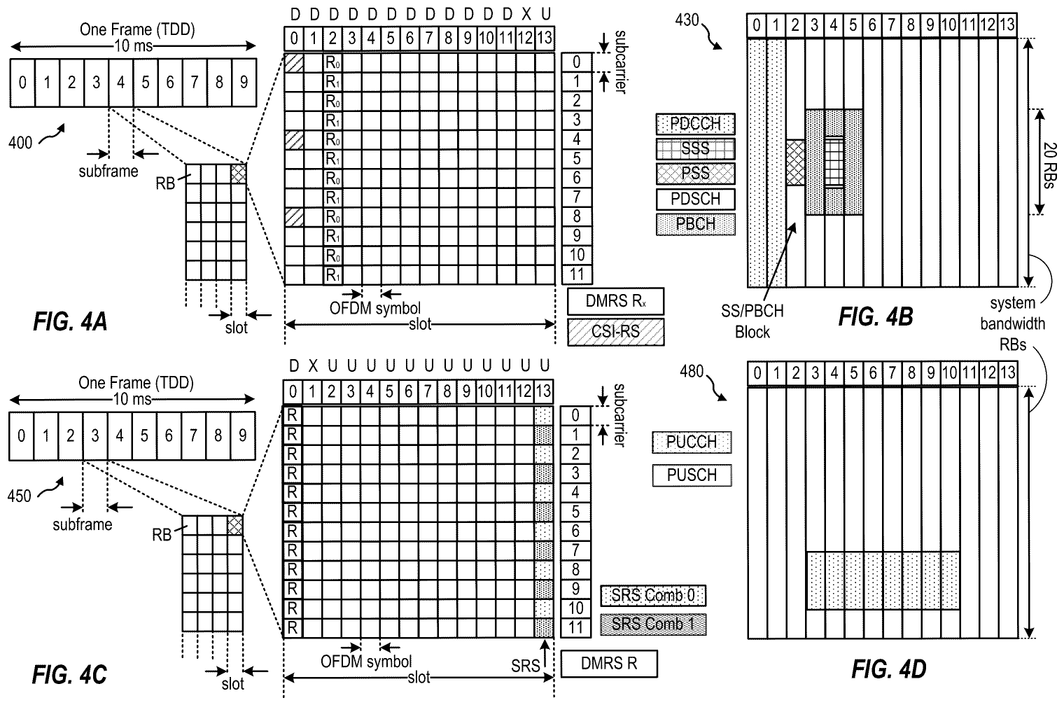

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIB s), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of a RAN Architecture

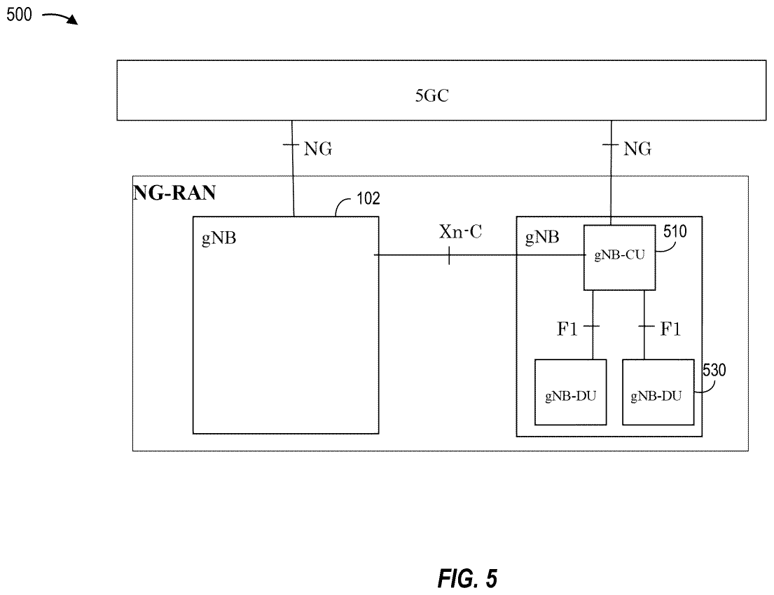

FIG. 5 illustrates an example architecture 500 of a radio access network (e.g., a NG-RAN). A gNB Central Unit (gNB-CU) 510 generally acts as a logical node hosting RRC, SDAP and PDCP protocols of the gNB that controls the operation of one or more gNB-DUs. The gNB-CU terminates the F1 interface connected with the gNB-DU.

A gNB Distributed Unit (gNB-DU) 530 generally acts as a logical node hosting RLC, MAC and PHY layers of the gNB, and its operation is controlled by gNB-CU. One gNB-DU may support one or multiple cells, while one cell is typically supported by only one gNB-DU. As illustrated, the gNB-DU terminates the F1 interface connected with the gNB-CU.

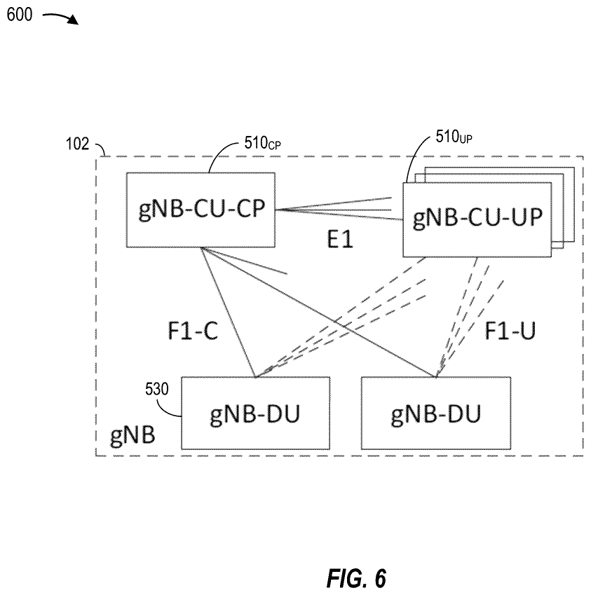

FIG. 6 illustrates an example architecture 600 with a separation of the gNB-CU control plane (gNB-CU-CP) and the gNB-CU user plane (gNB-CU-UP) functionality. A gNB may include a gNB-CU-CP 510cp, multiple gNB-CU-UPs 510ᵤₚ and multiple gNB-DUs 530.

As illustrated, the gNB-CU-CP may be connected to the gNB-DU through the F1-C interface. The gNB-CU-UP may be connected to the gNB-DU through the F1-U interface. The gNB-CU-UP may be connected to the gNB-CU-CP through the E1 interface.

One gNB-DU may be connected to only one gNB-CU-CP and one gNB-CU-UP may be connected to only one gNB-CU-CP. On the other hand, one gNB-DU may be connected to multiple gNB-CU-UPs under the control of the same gNB-CU-CP and one gNB-CU-UP may be connected to multiple DUs under the control of the same gNB-CU-CP.

### Overview of Mobility Scenarios

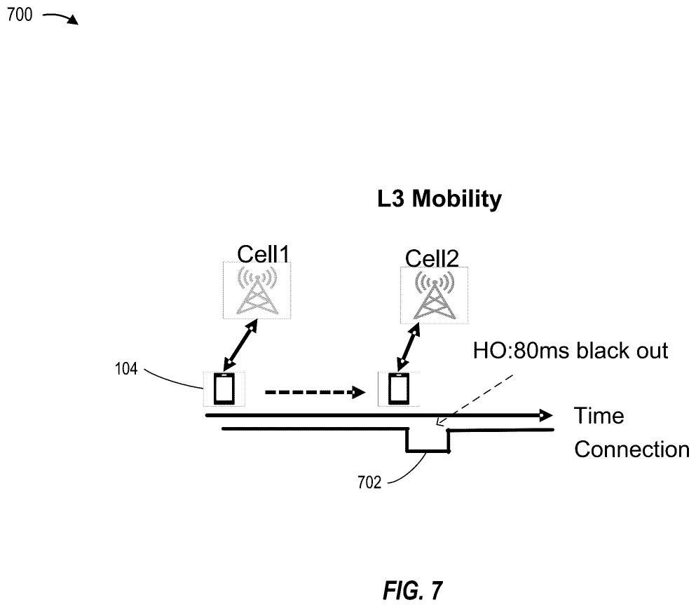

FIGS. 7-9 illustrate various mobility scenarios. FIG. 7 illustrates an example scenario 700 of higher layer (e.g., L3) based mobility. In this case, a serving cell is only changed through L3 handover (HO). In the illustrated example, the serving cell of a UE 104 is changed from Cell 1 to Cell 2. In this scenario, cell evaluation is relatively slow (e.g., on the order of −1 second). Every time an HO happens, an interruption in communication (e.g., or blackout) occurs, which may incur a substantial time cost (e.g., approx. 80 ms), as shown at 702. No data is exchanged during the blackout period.

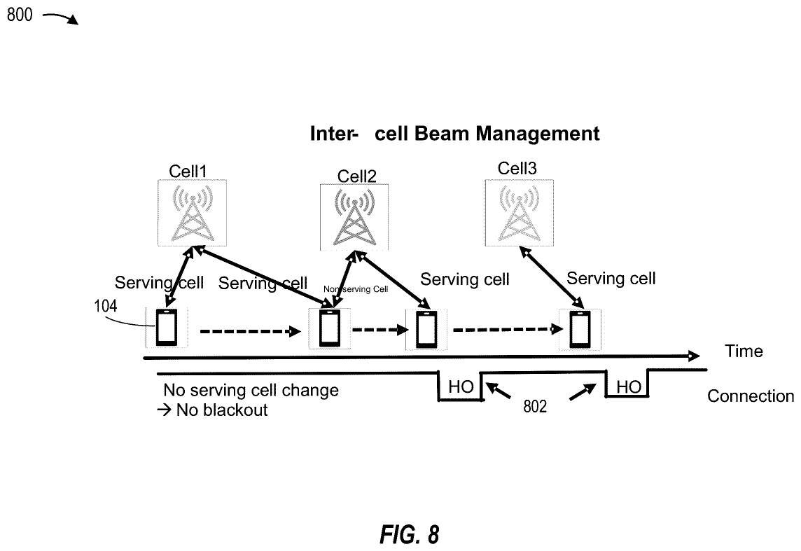

FIG. 8 illustrates an example mobility scenario 800 involving inter-cell beam management. In this case, a UE 104 is connected to serving cell for control and data. The UE may also be connected to additional cells for data (non-serving cells). Non-serving cells may be changed using L1/L2 signaling (e.g., with no blackout time). An L3 handover may not occur if one or more conditions are met, for example, if the serving cell reference signal received power (RSRP) is above a threshold (e.g., RSRP>threshold) or if a new serving cell is within a threshold (e.g., A dB) of an old serving cell. Otherwise, the UE may perform an L3 handover to the current best cell (which incurs a blackout time, as indicated at 802).

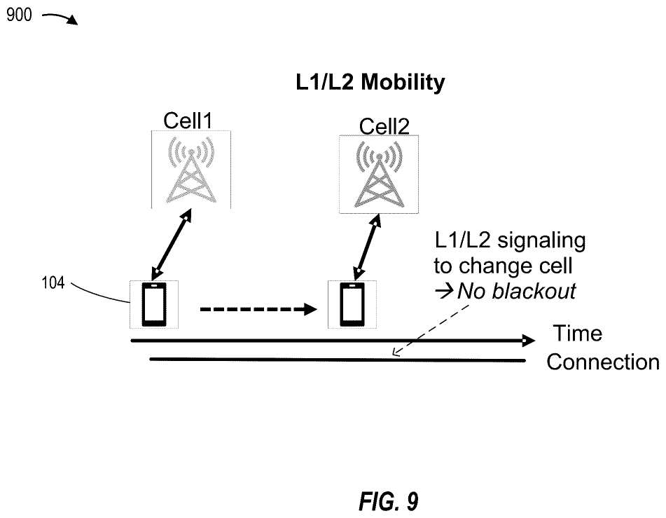

FIG. 9 illustrates an example mobility scenario 900 involving Layer1/Layer2 (L1/L2) triggered Mobility (or LTM). In this case, a serving cell may only be changed through dynamic (e.g., L1/L2) signaling, with no L3 handover involved. In this case, every time a serving cell changes, there may be no blackout time incurred. L1/L2 mobility signaling may be applicable between cells served by the same DU (intra-DU) or between cells in different DUs (inter-DU).

### Overview of Dynamic Signaling-Based Mobility

As noted above, dynamic mobility signaling (e.g., L1 and/or L2-centric mobility) may lead to more efficient beam management and may facilitate intra-cell and inter-cell mobility with reduced latency.

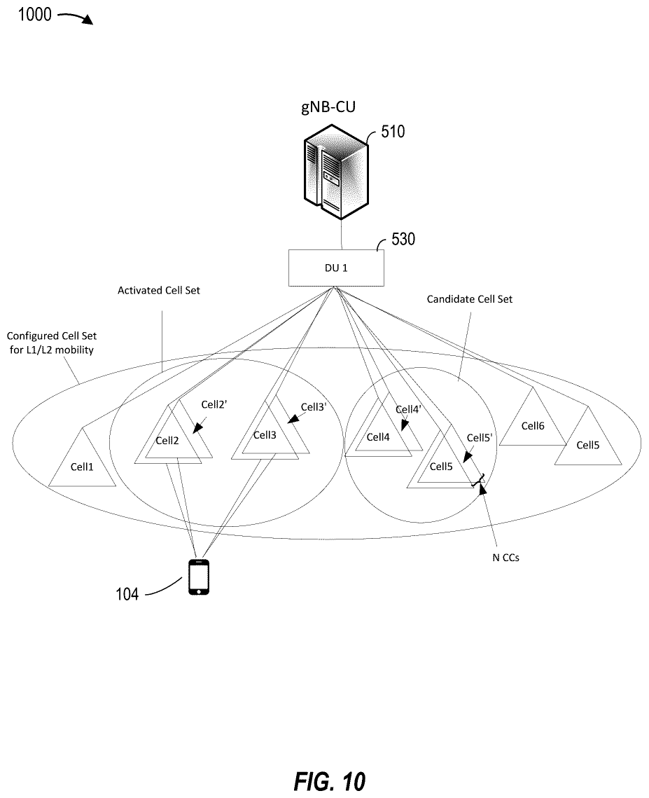

The general concept of L1/L2 based mobility signaling may be understood with reference to the example scenario 1000 shown in FIG. 10. As illustrated, the network may configure (e.g., via RRC signaling), a set of cells for L 1/L2 mobility (referred to herein as an L1/L2 Mobility Configured cell set). At any given time, the network may also configure (e.g., via L1/L2 signaling) an L1/L2 Mobility Activated cell set, which refers to a group of cells in the configured set that are activated and can be readily used for data and control transfer. The network may also configure (e.g., signal) an L1/L2 Mobility Deactivated cell set, which refers to a group of cells in the configured set that are deactivated and can be readily activated by L1/L2 signaling.

L1/L2 signaling may be used for mobility management of the activated set. For example, L1/L2 signaling may be used to activate/deactivate cells in the set, select beams within the activated cells, and update/switch a primary cell (PCell). This dynamic signaling may help to provide seamless mobility within the activated cells in the set. In other words, as the UE moves, the cells from the set may be deactivated and activated by L1/L2 signaling. The cells to activate and deactivate may be based on various factors, such as signal quality (e.g., measurements) and loading.

As in the example illustrated in FIG. 10, in some cases, all cells in the L1/L2 Mobility Configured cell set may belong to the same DU 530 of a CU 510. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

In some cases, the UE may be provided with a subset of deactivated cells (e.g., as a candidate cell set), from which the UE could autonomously choose to add to the activated cell set. The decision of whether to add a cell from the candidate cell set to the activated cell set may be based on various factors, such as measured channel quality and loading information. In some cases, an ability of the UE to autonomously choose to add to the activated cell set may be similar to a UE decision when configured for Conditional Handover (CHO) for fast and efficient addition of the prepared cells.

As illustrated in FIG. 10, each cell may be served by an RU. Each of the RUs may have multi-carrier (e.g., N CCs) support. In such cases, each CC may be a cell (e.g., Cell 2 and Cell 2′ may be different CCs of the same RU). In such cases, activation/deactivation can be done in groups of carriers (e.g., cells).

For PCell management, L1/L2 signaling may be used to set (e.g., select) the PCell out of the preconfigured options within the activated cell set. In some cases, L3 mobility may be used for PCell change (e.g., L3 handover) when a new PCell is not from the activated cell set for L1/L2 mobility. In such cases, RRC signaling may update the set of cells for L1/L2 mobility at L3 handover.

### Aspects Related to Fast Data Path Switch for Lower Layer Mobility Scenarios

According to certain aspects of the present disclosure, however, a CU may activate forwarding of F1-U PDUs towards a candidate DU before or after the UE executes an L1/L2-triggered mobility to the associated target cell.

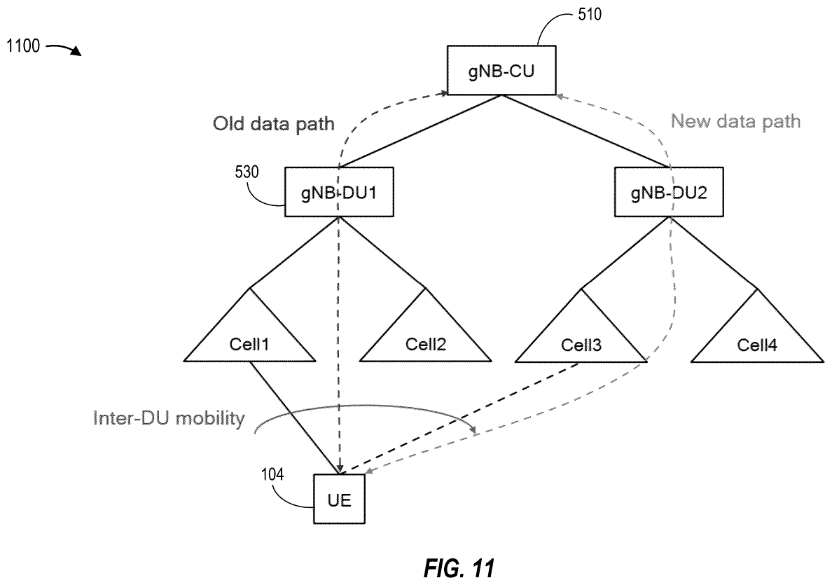

The techniques proposed herein may be applied, for example, in the scenario 1100 shown in FIG. 11. In the illustrated example, of inter-DU mobility, a UE switches cells to a new gNB-DU 530 via L1/L2-triggered mobility (LTM). In this case, the data path for the UE has to be switched to the new DU.

It may be noted that in L3 mobility, the gNB-CU sends an HO command and gNB-CU controls data path switch. In LTM, the gNB-DU sends a cell-switch command, while the gNB-CU controls data path switch. For this reason, the gNB-CU typically either waits until it receives confirmation that the UE executed the cell switch successfully to switch the data path, or it blindly performs the switch, duplicates, and/or multiplexes packet transmissions onto multiple data paths. This may be sub-optimal and could be enhanced if the gNB-DU informs the gNB-CU about the cell switch, as proposed herein.

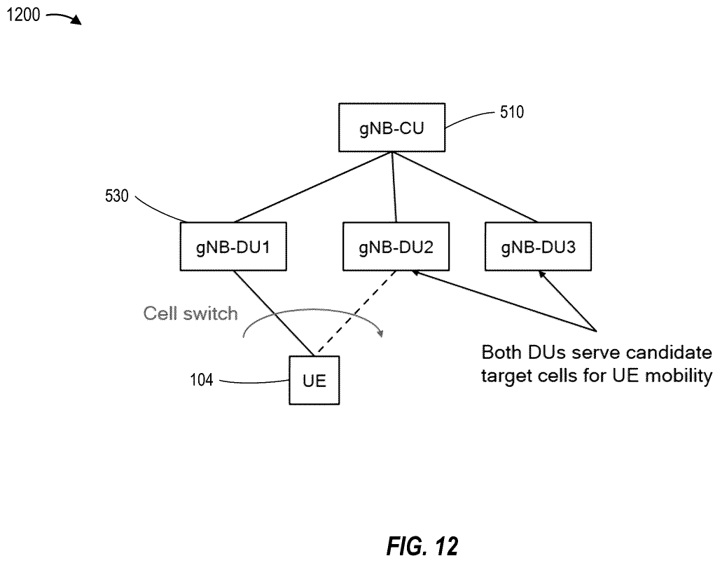

As noted above, in some cases, a gNB-CU-CP may setup the F1-U between the gNB-CU-UP and a candidate gNB-DU before the UE executes L1/L2-triggered mobility, as illustrated in FIG. 12. As shown in the illustrated example, multiple DUs (e.g., gNB-DU2 and gNB-DU3) may serve candidate target cells for UE mobility, although one DU (e.g., gNB-DU2) may serve multiple candidate target cells. Further, the one or multiple DUs may serve one or multiple target cell groups. The F1-Us towards the one or multiple candidate DUs and the source DU may be retained as the UE performs one or subsequent cell/cell group switches. Additionally or alternatively, new F1-Us may be setup and/or some F1-Us may be released. Furthermore, the bearer context associated with the F1-U tunnel may be activated, suspended, or resumed throughout the one or more successive cell/cell-group switches performed by the UE.

In such cases, there are various options for forwarding downlink (DL) data on the F1-U. According to a first option, the gNB-CU only activates forwarding of the F1-U protocol data units (PDUs) towards the candidate DU after the UE successfully accesses a target cell served by the candidate DU. While this first option may help minimize redundant transmission of PDUs by only activating F1-U towards the selected target cell, there may be some interruption time of the UP. According to a second option, a data path may be pre-emptively setup towards all DUs that serve a candidate cell for UE mobility before the UE does cell switch. Potentially, data may be forwarded to all DUs and, when the UE performs a cell switch, only the data path to the DU serving the target cell may be activated. This option may be associated with additional overhead due to resource reservation at all candidate target DUs

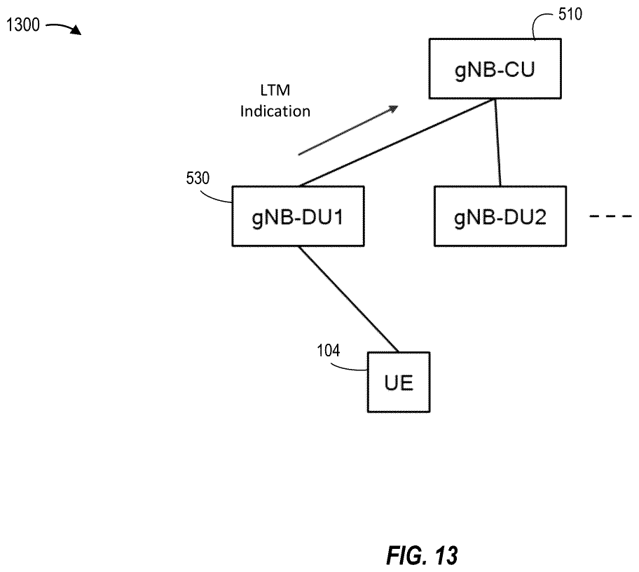

According to aspects of the present disclosure, as illustrated in the scenario 1300 shown in FIG. 13, a source DU (gNB-DU1) 530 may transmit an indication to trigger the CU 510 to begin forwarding data to the UE via a second data path involving a second DU (e.g., gNB-DU2) involved in the cell switch. The techniques proposed herein may help implement an efficient data path switch/setup during lower-layer inter-DU UE mobility, while limiting the amount of overhead.

As illustrated in FIG. 13, the source gNB-DU (e.g., DU1) may send some type of indication of LTM to the gNB-CU. Based on the indication, the gNB-CU may set up (e.g., or activate) a bearer to a target gNB-DU (e.g., DU2) that serves a candidate cell for the UE LTM.

There are various conditions that may trigger the source gNB-DU to send an LTM indication. For example, the source gNB-DU may send an indication upon sending cell switch command to UE or based on an L1 measurement report from the UE, where the L1 measurement fulfills a condition. In some cases, the source gNB-DU may send an indication prior to triggering a UE cell switch with some time period. In some cases, DU1 may send the indication based on some type of configuration from the CU (e.g., that configures the aforementioned time period or measurement condition).

The source gNB-DU may include various types of information with the LTM indication related to the cell switch. In this context, a cell switch may refer to a switch between cells in a same cell group or a cell group switch (e.g., in such cases, the UE may be configured with carrier aggregation before the switch and/or after the cell switch). For example, the indication may include a target cell ID (of the target of the cell switch), cell group ID, indication of a configuration (e.g., RRC configuration) of the UE associated with a target cell or target cell group, an indication of a time to trigger the cell switch, and/or a report of packets that were successfully or unsuccessfully transmitted to the UE. The LTM indication may be carried, for example, in an application protocol (e.g., F1-AP) message or a user plane (e.g., NR UP) message

In some cases, a gNB-CU-CP may set up, modify, release, suspend, and/or resume the bearer context at gNB-CU-UP. This approach may have the following consequences. Activation/deactivation of old and new data paths (e.g., including other data paths that are neither the source data path nor the target data path) may be managed by the CU-CP. Thus, an indication (e.g., from a source DU) that triggers early data forwarding as described above, may go from the source DU (DU1) to CU-CP, which may then activate the bearer context at CU-UP towards DU2.

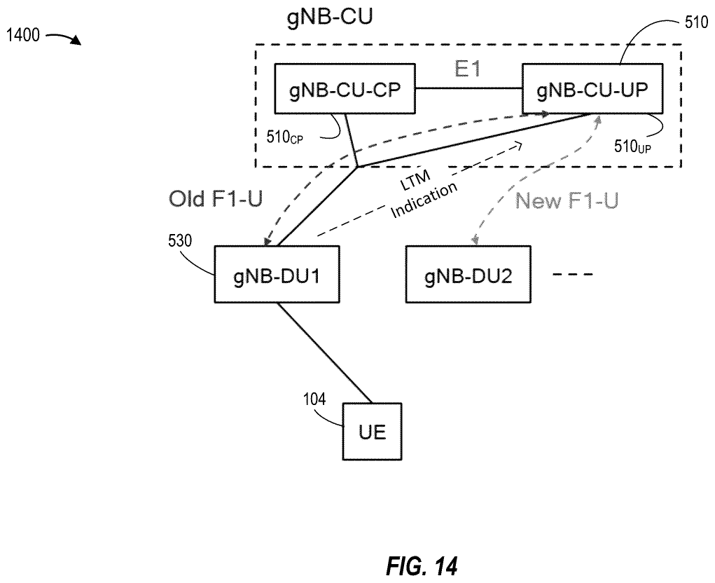

Aspects of the present disclosure, however, may help enable faster switching to a new data path. For example, as illustrated in FIG. 14, a source DU (e.g., gNB-DU1) may send an LTM indication directly to gNB-CU-UP, as opposed to sending the LTM indication to the gNB CU-CP (e.g., which would interact with the gNB-CU-UP on the E1 interface), incurring additional latency. The indication may be bearer-specific or UE specific. Further, the indication may be carried in a single F1-U instance, but may also apply to other F1-Us of same UE. The indication may be carried in an NR-UP message, such as a Downlink Data Delivery Status (DDDS) message.

According to certain aspects of the present disclosure, a UE may be single-connected to one DU at a time, and may switch its connection between DUs based on link conditions, for example, using LTM. Alternatively, the UE may be dual-connected, but one of its connections may still be considered switched between DUs, based on the link condition of that connection. Techniques described herein, utilizing an LTM indication, enable the gNB-CU(-UP) to switch or multiplex data transmissions to the DUs among which the UE switches its connection.

The dual-connectivity scenario described above may involve two cell groups (e.g., a master cell group or MCG and a secondary cell group or SCG). In some cases, the UE may be configured with candidate cells or cell groups for LTM hosted by one DU, two DUs, or multiple DUs. For the MCG/SCG scenario, the CU-UP may be configured with multiple F1-U tunnels of the same UE radio bearer towards the MCG and SCG (e.g., a split radio bearer). If the CU-UP receives an indication that link condition corresponding to one cell group (MCG or SCG) has degraded, this information may be sufficient to let the gNB-CU(-UP) know that it may switch the traffic to the F1-U tunnel terminating at the other cell group. Aspects of the present disclosure may help provide additional information that enables the gNB-CU(-UP) to determine to which of the potentially several F1-U tunnels traffic should be switched. Such information may be provided by the source DU, as described above. Assistance configuration may further be provisioned on the CU-UP by the CU-CP, for example, via a mapping between the information from the source DU and the F1-U tunnels towards the DUs that host the UE candidate cell groups.

In some cases, the gNB-CU-UP may activate one or more F1-Us to the gNB-DU2 based on receiving the indication (e.g., directly from the source DU) as shown in FIG. 14.

In some cases, to support this feature, the gNB-CU-UP may be configured to allow it to infer which bearers via which gNB-DUs it should activate (e.g., and/or deactivate) based on the received indication. This may be provided as a mapping, for example.

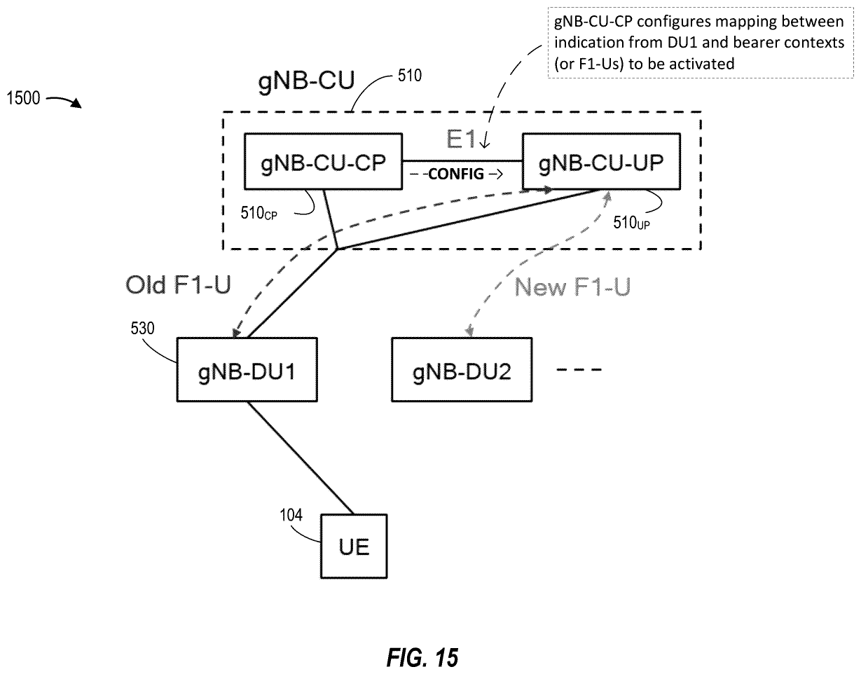

As illustrated in FIG. 15, in some cases, such a mapping could be configured by the gNB-CU-CP. For example the gNB-CU-CP may configure a mapping between the indication from the source DU (DU1) and bearer contexts (or F1-Us) to be activated (e.g., towards DU2) and/or to be de-activated. In some cases, a single bearer context may include multiple F1-U information. In other cases, the CU-CP could provide the mapping to the CU-UP. In this context, activation may include resuming transmission if the user plane interface was setup before but was suspended, while deactivation may include suspending a context (e.g., or F1-U tunnel), stopping transmission on the tunnel, releasing bearer context, and/or releasing the tunnel.

For example, the mapping could be from an old bearer to a new bearer (e.g., based on an old/new bearer ID and/or ID of UE's target cell) and a new bearer ID. In some cases, a bearer ID could be indicated by one or more of UE ID, data radio bearer (DRB) ID, or UP transport layer information (e.g., of a target DU, DU2) including at least one of General Packet Radio Service (GPRS) Tunneling Protocol (GTP) Tunnel Endpoint Identifier (TEID), transport layer address (e.g., gNB-DU ID) which could refer to Internet Protocol (IP) address information, or transport network layer address (TNL) information.

In some cases, activation of new bearer may involve retransmission of unsuccessfully delivered bearer PDUs to the UE and transmission of new bearer PDUs to DU2. As noted above, the LTM indication may include an indication of which PDUs have/have not been successfully delivered to the UE.

In some cases, the gNB-CU-UP may further deactivate bearers towards other DUs/cells (e.g., DU1 or DU3 or source cell or unselected candidate cell) following the reception of the indication. In the case of CU-UP relocation, a first CU-UP (e.g., CU-UP1) may be triggered by an indication from DU1 to forward data packets to a second CU-UP (CU-UP2), for example, based on a configuration from CU-CP.

In some cases, the old F1-U and the new F1-U may terminate at the same DU. In other words the source DU (DU1) and target DU (DU2) may be the same. For example, this may be the case if a cell switch for a UE is between cells served by the same DU (e.g., intra-DU).

### Example Operations of a First Distributed Unit

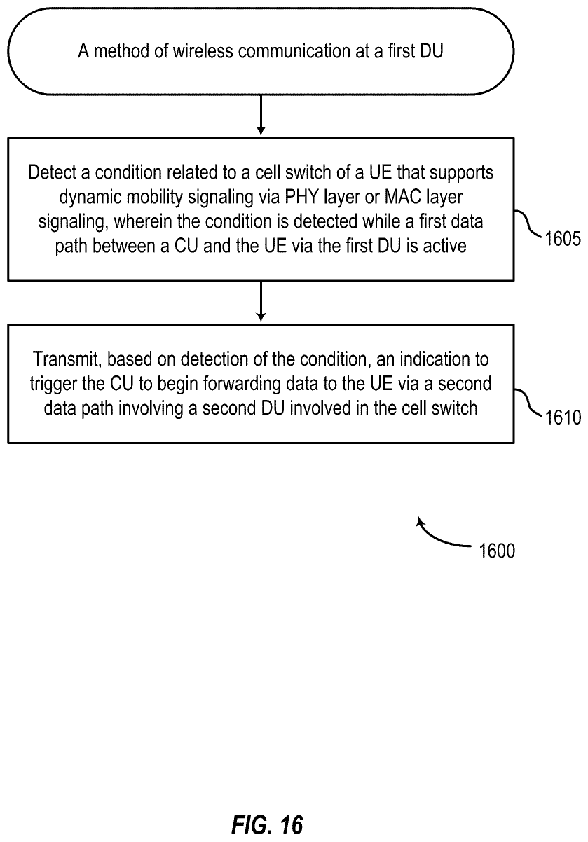

FIG. 16 shows an example of a method 1600 of wireless communication at a first DU, such as a BS 102 of FIGS. 1 and 3, or a disaggregated base station as discussed with respect to FIG. 2.

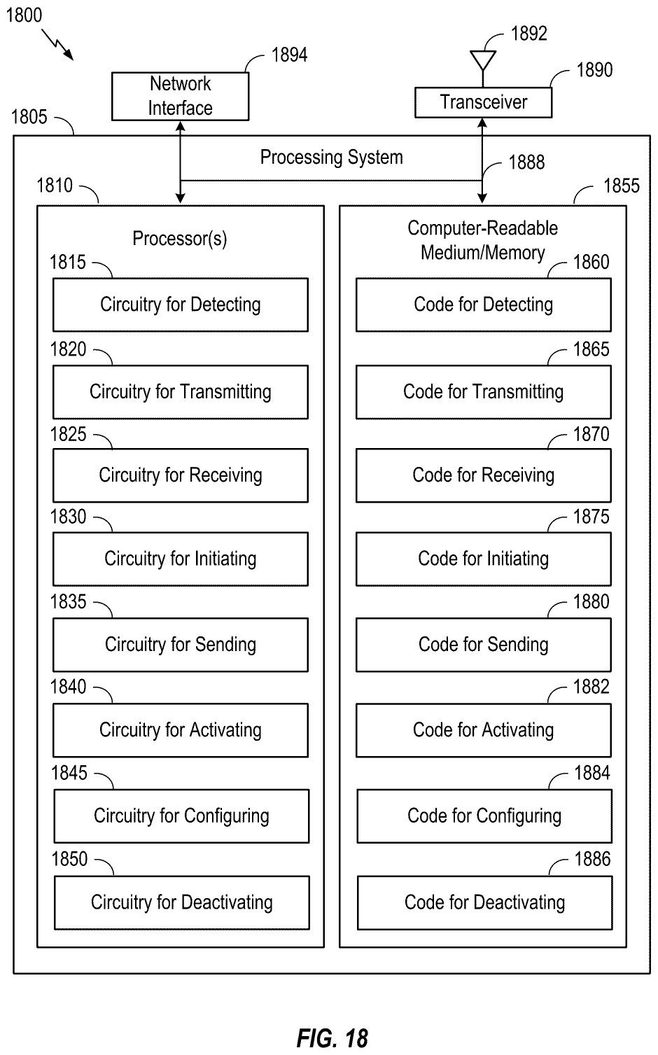

Method 1600 begins at step 1605 with detecting a condition related to a cell switch of a UE that supports dynamic mobility signaling via PHY layer or MAC layer signaling, wherein the condition is detected while a first data path between a CU and the UE via the first DU is active. In some cases, the operations of this step refer to, or may be performed by, circuitry for detecting and/or code for detecting as described with reference to FIG. 18.

Method 1600 then proceeds to step 1610 with transmitting, based on detection of the condition, an indication to trigger the CU to begin forwarding data to the UE via a second data path involving a second DU involved in the cell switch. In some cases, the operations of this step refer to, or may be performed by, circuitry for transmitting and/or code for transmitting as described with reference to FIG. 18.

In some aspects, the condition involves at least one of: the first DU transmitting a cell switch command to the UE; the first DU receiving, from the UE, acknowledgment of a cell switch command; a PHY layer measurement report from the UE; or a time period prior to triggering the cell switch.

In some aspects, the method 1600 further includes receiving, from the CU, configuration information indicating at least one of: a condition related to the measurement report or the time period. In some cases, the operations of this step refer to, or may be performed by, circuitry for receiving and/or code for receiving as described with reference to FIG. 18.

In some aspects, the indication comprises at least one of: a target cell ID; an indication of a time to trigger the cell switch; or a report indicating one or more packets that were successfully or unsuccessfully transmitted from the first DU to the UE.

In some aspects, the indication is transmitted via at least one of: an AP message or a UP message.

In some aspects, the indication is transmitted to a UP of the CU.

In some aspects, the indication is bearer-specific or UE-specific.

In some aspects, the indication is carried on a first user plane interface of the UE and applies to at least a second user plane interface of the UE.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

### Example Operations of a Central Unit

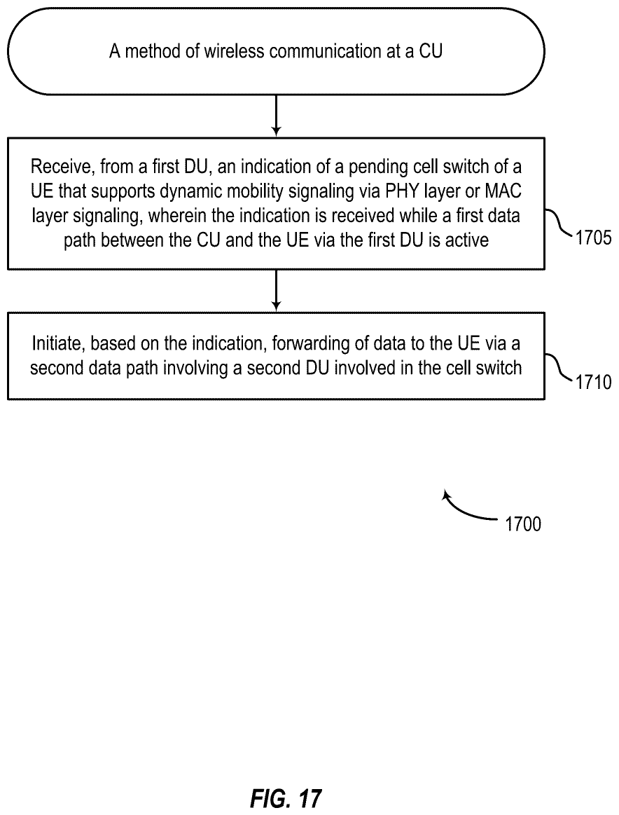

FIG. 17 shows an example of a method 1700 of wireless communication at a CU, such as a BS 102 of FIGS. 1 and 3, or a disaggregated base station as discussed with respect to FIG. 2.

Method 1700 begins at step 1705 with receiving, from a first DU, an indication of a pending cell switch of a UE that supports dynamic mobility signaling via PHY layer or MAC layer signaling, wherein the indication is received while a first data path between the CU and the UE via the first DU is active. In this context, a pending cell switch may mean the cell switch has not yet started or has been initiated. In some cases, the operations of this step refer to, or may be performed by, circuitry for receiving and/or code for receiving as described with reference to FIG. 18.

Method 1700 then proceeds to step 1710 with initiating, based on the indication, forwarding of data to the UE via a second data path involving a second DU involved in the cell switch. In some cases, the operations of this step refer to, or may be performed by, circuitry for initiating and/or code for initiating as described with reference to FIG. 18.

In some aspects, the method 1700 further includes sending, to the first DU, configuration information indicating a condition that triggers the first DU to transmit the indication. In some cases, the operations of this step refer to, or may be performed by, circuitry for sending and/or code for sending as described with reference to FIG. 18.

In some aspects, the indication comprises at least one of: a target cell ID; an indication of a time to trigger the cell switch; or a report indicating one or more packets that were successfully or unsuccessfully transmitted from the first DU to the UE.

In some aspects, the indication is received via at least one of: an AP message or a UP message.

In some aspects, the indication is received via a UP of the CU.

In some aspects, the indication is bearer-specific or UE-specific.

In some aspects, the indication is carried on a first user plane interface of the UE and applies to at least a second user plane interface of the UE.

In some aspects, the method 1700 further includes activating one or more user plane interfaces towards the second DU, in response to receiving the indication. In some cases, the operations of this step refer to, or may be performed by, circuitry for activating and/or code for activating as described with reference to FIG. 18.

In some aspects, the method 1700 further includes configuring, via a CP of the CU, a mapping between the indication from the first DU and bearer contexts to be activated towards the second DU. In some cases, the operations of this step refer to, or may be performed by, circuitry for configuring and/or code for configuring as described with reference to FIG. 18.

In some aspects, the mapping comprises a mapping from an old bearer to a new bearer, based on an old bearer ID or an ID of a target cell and a new bearer ID.

In some aspects, the activating comprises: retransmitting of unsuccessfully delivered bearer PDUs to the UE via the second DU, wherein the unsuccessfully delivered PDUs are identified in the indication; and transmitting new bearer PDUs to the UE via the second DU.

In some aspects, the method 1700 further includes deactivating, in response to receiving the indication, at least one of: one or more user plane interfaces towards the first DU; or one or more user plane interfaces towards a third DU serving a candidate cell that was not selected for the cell switch. In some cases, the operations of this step refer to, or may be performed by, circuitry for deactivating and/or code for deactivating as described with reference to FIG. 18.

In some aspects, the method 1700 further includes configuring, via a CP of the CU, a mapping between the indication from the first DU and bearer contexts to be deactivated. In some cases, the operations of this step refer to, or may be performed by, circuitry for configuring and/or code for configuring as described with reference to FIG. 18.

In some aspects, in case of CU UP relocation, the CU UP is triggered by the indication to forward data packets to a new CU UP based on a configuration from a CU CP.

In some aspects, the first DU and second DU are the same DU, such that the first data path and second data path terminate at the same DU.

In one aspect, method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Device

FIG. 18 depicts aspects of an example communications device 1800. In some aspects, communications device 1800 is a first DU or a CU as discussed in more detail herein. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1890 (e.g., a transmitter and/or a receiver). In some aspects, processing system 1805 may be coupled to a network interface 1894 that is configured to obtain and send signals for the communications device 1800 via communication link(s), such as a backhaul link, midhaul link, and/or fronthaul link as described herein, such as with respect to FIG. 2. The transceiver 1890 is configured to transmit and receive signals for the communications device 1800 via the antenna 1892, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1855 via a bus 1888. In certain aspects, the computer-readable medium/memory 1855 is configured to store instructions (e.g., computer-executable code) that when executed by the one or more processors 1810, cause the one or more processors 1810 to perform: the method 1600 described with respect to FIG. 16, or any aspect related to it; and/or the method 1700 described with respect to FIG. 17, or any aspect related to it. Note that reference to a processor performing a function of communications device 1800 may include one or more processors 1810 performing that function of communications device 1800.

In the depicted example, computer-readable medium/memory 1855 stores code (e.g., executable instructions), such as code for detecting 1860, code for transmitting 1865, code for receiving 1870, code for initiating 1875, code for sending 1880, code for activating 1882, code for configuring 1884, and code for deactivating 1886. Processing of the code for detecting 1860, code for transmitting 1865, code for receiving 1870, code for initiating 1875, code for sending 1880, code for activating 1882, code for configuring 1884, and code for deactivating 1886 may cause the communications device 1800 to perform: the method 1600 described with respect to FIG. 16, or any aspect related to it; and/or the method 1700 described with respect to FIG. 17, or any aspect related to it.

The one or more processors 1810 include circuitry configured to implement (e.g., execute) the code stored in the computer-readable medium/memory 1855, including circuitry for detecting 1815, circuitry for transmitting 1820, circuitry for receiving 1825, circuitry for initiating 1830, circuitry for sending 1835, circuitry for activating 1840, circuitry for configuring 1845, and circuitry for deactivating 1850. Processing with circuitry for detecting 1815, circuitry for transmitting 1820, circuitry for receiving 1825, circuitry for initiating 1830, circuitry for sending 1835, circuitry for activating 1840, circuitry for configuring 1845, and circuitry for deactivating 1850 may cause the communications device 1800 to perform: the method 1600 described with respect to FIG. 16, or any aspect related to it; and/or the method 1700 described with respect to FIG. 17, or any aspect related to it.

Various components of the communications device 1800 may provide means for performing: the method 1600 described with respect to FIG. 16, or any aspect related to it; and/or the method 1700 described with respect to FIG. 17, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1890 and the antenna 1892 of the communications device 1800 in FIG. 18. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1890 and the antenna 1892 of the communications device 1800 in FIG. 18.

### Example Clauses

Implementation examples are described in the following numbered clauses:

Clause 1: A method of wireless communication at a first DU, comprising: detecting a condition related to a cell switch of a UE that supports dynamic mobility signaling via PHY layer or MAC layer signaling, wherein the condition is detected while a first data path between a CU and the UE via the first DU is active; and transmitting, based on detection of the condition, an indication to trigger the CU to begin forwarding data to the UE via a second data path involving a second DU involved in the cell switch.

Clause 2: The method of Clause 1, wherein the condition involves at least one of: the first DU transmitting a cell switch command to the UE; the first DU receiving, from the UE, acknowledgment of a cell switch command; a PHY layer measurement report from the UE; or a time period prior to triggering the cell switch.

Clause 3: The method of Clause 2, further comprising: receiving, from the CU, configuration information indicating at least one of: a condition related to the measurement report or the time period.

Clause 4: The method of any one of Clauses 1-3, wherein the indication comprises at least one of: a target cell ID; an indication of a time to trigger the cell switch; or a report indicating one or more packets that were successfully or unsuccessfully transmitted from the first DU to the UE.

Clause 5: The method of any one of Clauses 1-4, wherein the indication is transmitted via at least one of: an AP message or a UP message.

Clause 6: The method of any one of Clauses 1-5, wherein the indication is transmitted to a UP of the CU.

Clause 7: The method of Clause 6, wherein the indication is bearer-specific or UE-specific.

Clause 8: The method of Clause 6, wherein the indication is carried on a first user plane interface of the UE and applies to at least a second user plane interface of the UE.

Clause 9: A method of wireless communication at a central unit (CU), comprising: receiving, from a first DU, an indication of a pending cell switch of a UE that supports dynamic mobility signaling via PHY layer or MAC layer signaling, wherein the indication is received while a first data path between the CU and the UE via the first DU is active; and initiating, based on the indication, forwarding of data to the UE via a second data path involving a second DU involved in the cell switch.

Clause 10: The method of Clause 9, further comprising: sending, to the first DU, configuration information indicating a condition that triggers the first DU to transmit the indication.

Clause 11: The method of any one of Clauses 9-10, wherein the indication comprises at least one of: a target cell ID; an indication of a time to trigger the cell switch; or a report indicating one or more packets that were successfully or unsuccessfully transmitted from the first DU to the UE.

Clause 12: The method of any one of Clauses 9-11, wherein the indication is received via at least one of: an AP message or a UP message.

Clause 13: The method of any one of Clauses 9-12, wherein the indication is received via a UP of the CU.

Clause 14: The method of Clause 13, wherein the indication is bearer-specific or UE-specific.

Clause 15: The method of Clause 13, wherein the indication is carried on a first user plane interface of the UE and applies to at least a second user plane interface of the UE.

Clause 16: The method of Clause 13, further comprising: activating one or more user plane interfaces towards the second DU, in response to receiving the indication.

Clause 17: The method of Clause 16, further comprising: configuring, via a CP of the CU, a mapping between the indication from the first DU and bearer contexts to be activated towards the second DU.

Clause 18: The method of Clause 17, wherein the mapping comprises a mapping from an old bearer to a new bearer, based on an old bearer ID or an ID of a target cell and a new bearer ID.

Clause 19: The method of Clause 16, wherein the activating comprises: retransmitting of unsuccessfully delivered bearer PDUs to the UE via the second DU, wherein the unsuccessfully delivered PDUs are identified in the indication; and transmitting new bearer PDUs to the UE via the second DU.

Clause 20: The method of Clause 13, further comprising: deactivating, in response to receiving the indication, at least one of: one or more user plane interfaces towards the first DU; or one or more user plane interfaces towards a third DU serving a candidate cell that was not selected for the cell switch.

Clause 21: The method of Clause 20, further comprising: configuring, via a CP of the CU, a mapping between the indication from the first DU and bearer contexts to be deactivated.

Clause 22: The method of Clause 13, wherein, in case of CU UP relocation, the CU UP is triggered by the indication to forward data packets to a new CU UP based on a configuration from a CU CP.

Clause 23: The method of any one of Clauses 9-22, wherein the first DU and second DU are the same DU, such that the first data path and second data path terminate at the same DU.

Clause 24: An apparatus, comprising: a memory comprising executable instructions; and a processor configured to execute the executable instructions and cause the apparatus to perform a method in accordance with any one of Clauses 1-23.

Clause 25: An apparatus, comprising means for performing a method in accordance with any one of Clauses 1-23.

Clause 26: A non-transitory computer-readable medium comprising executable instructions that, when executed by a processor of an apparatus, cause the apparatus to perform a method in accordance with any one of Clauses 1-23.

Clause 27: A computer program product embodied on a computer-readable storage medium comprising code for performing a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising: at least one memory comprising computer-executable instructions; and one or more processors configured to execute the computer-executable instructions and cause the apparatus to:
detect a condition related to a cell switch of a user equipment (UE) that supports dynamic mobility signaling via physical (PHY) layer or medium access control (MAC) layer signaling, wherein the condition is detected while a first data path between a centralized unit (CU) and the UE via a first distributed unit (DU) is active; and
transmit, based on detection of the condition, an indication to trigger the CU to begin forwarding data to the UE via a second data path involving a second DU involved in the cell switch.

2. The apparatus of claim 1, wherein the condition involves at least one of:
the first DU transmitting a cell switch command to the UE;
the first DU receiving, from the UE, acknowledgment of a cell switch command;
a physical (PHY) layer measurement report from the UE; or
a time period prior to triggering the cell switch.

3. The apparatus of claim 2, wherein the one or more processors are further configured to cause the apparatus to receive, from the CU, configuration information indicating at least one of: a condition related to the PHY layer measurement report or the time period.

4. The apparatus of claim 1, wherein the indication comprises at least one of:
a target cell identifier (ID);
an indication of a time to trigger the cell switch; or
a report indicating one or more packets that were successfully or unsuccessfully transmitted from the first DU to the UE.

5. The apparatus of claim 1, wherein the indication is transmitted via at least one of: an application protocol (AP) message or a user plane (UP) message.

6. The apparatus of claim 1, wherein the indication is transmitted to a user plane (UP) of the CU.

7. The apparatus of claim 6, wherein the indication is bearer-specific or UE-specific.

8. The apparatus of claim 6, wherein the indication is carried on a first user plane interface of the UE and applies to at least a second user plane interface of the UE.

9. An apparatus, comprising: at least one memory comprising computer-executable instructions; and one or more processors configured to execute the computer-executable instructions and cause the apparatus to:
receive, from a first distributed unit (DU), an indication of a pending cell switch of a user equipment (UE) that supports dynamic mobility signaling via physical (PHY) layer or medium access control (MAC) layer signaling, wherein the indication is received while a first data path between a centralized unit (CU) and the UE via the first DU is active; and
initiate, based on the indication, forwarding of data to the UE via a second data path involving a second DU involved in the cell switch.

10. The apparatus of claim 9, wherein the one or more processors are further configured to cause the apparatus to send, to the first DU, configuration information indicating a condition that triggers the first DU to transmit the indication.

11. The apparatus of claim 9, wherein the indication comprises at least one of:
a target cell identifier (ID);
an indication of a time to trigger the cell switch; or
a report indicating one or more packets that were successfully or unsuccessfully transmitted from the first DU to the UE.

12. The apparatus of claim 9, wherein the indication is received via at least one of: an application protocol (AP) message or a user plane (UP) message.

13. The apparatus of claim 9, wherein the indication is received via a user plane (UP) of the CU.

14. The apparatus of claim 13, wherein the indication is bearer-specific or UE-specific.

15. The apparatus of claim 13, wherein the indication is carried on a first user plane interface of the UE and applies to at least a second user plane interface of the UE.

16. The apparatus of claim 13, wherein the one or more processors are further configured to cause the apparatus to activate one or more user plane interfaces towards the second DU, in response to receiving the indication.

17. The apparatus of claim 16, wherein the one or more processors are further configured to cause the apparatus to configure, via a control plane (CP) of the CU, a mapping between the indication from the first DU and bearer contexts to be activated towards the second DU.

18. The apparatus of claim 17, wherein the mapping comprises a mapping from an old bearer to a new bearer, based on an old bearer ID or an ID of a target cell and a new bearer ID.

19. The apparatus of claim 16, wherein in order to activate one or more user plane interfaces towards the second DU, the one or more processors are further configured to:
retransmit of unsuccessfully delivered bearer protocol data units (PDUs) to the UE via the second DU, wherein the unsuccessfully delivered PDUs are identified in the indication; and
transmit new bearer PDUs to the UE via the second DU.

20. The apparatus of claim 13, wherein the one or more processors are further configured to cause the apparatus to, in response to reception of the indication, deactivate at least one of:
one or more user plane interfaces towards the first DU; or
one or more user plane interfaces towards a third DU serving a candidate cell that was not selected for the cell switch.

21. The apparatus of claim 20, wherein the one or more processors are further configured to cause the apparatus to configure, via a control plane (CP) of the CU, a mapping between the indication from the first DU and bearer contexts to be deactivated.

22. The apparatus of claim 13, wherein, in case of CU user plane (UP) relocation, the CU UP is triggered by the indication to forward data packets to a new CU UP based on a configuration from a CU control plane (CU CP).

23. The apparatus of claim 9, wherein the first DU and second DU are a same DU, such that the first data path and second data path terminate at the same DU.

24. A method of wireless communication at a first distributed unit (DU), comprising:
detecting a condition related to a cell switch of a user equipment (UE) that supports dynamic mobility signaling via physical (PHY) layer or medium access control (MAC) layer signaling, wherein the condition is detected while a first data path between a centralized unit (CU) and the UE via the first DU is active; and
transmitting, based on detection of the condition, an indication to trigger the CU to begin forwarding data to the UE via a second data path involving a second DU involved in the cell switch.

25. A method of wireless communication at a centralized unit (CU), comprising:
receiving, from a first distributed unit (DU), an indication of a pending cell switch of a user equipment (UE) that supports dynamic mobility signaling via physical (PHY) layer or medium access control (MAC) layer signaling, wherein the indication is received while a first data path between the CU and the UE via the first DU is active; and
initiating, based on the indication, forwarding of data to the UE via a second data path involving a second DU involved in the cell switch.
